(19) United States
(12) Patent Application Publication
(10) Pub. No.: US 2004/0000226 A1
(43) Pub. Date: Jan. 1, 2004

(54) Electronic metronome

(75) Inventor: Yoshiaki Sakamoto, Tokyo (JP)

Correspondence Address: ROSSI & ASSOCIATES, P.O. BOX 826, ASHBURN, VA, 20146-0826, US

(73) Assignee: RIC Company, Ltd.

(21) Appl. No.: 10/382,048

(22) Filed: Mar. 5, 2003

(30) Foreign Application Priority Data
Jul. 1, 2002 (JP) 2002-191724

(51) Int. Cl. G10H 1/40; G10H 7/00

(52) U.S. Cl. 84/611

(57) ABSTRACT

With a clip and a lower casing sandwiching a concha of a user so that the lower casing is positioned on the ear, a speaker generates a rhythm tone with a small volume in the vicinity of an ear hole of the user. A rhythm speed and type of the rhythm tone are set by operating switches with reference to a liquid crystal display. An integrated circuit has a memory device for holding recorded data of an analog sound and a reproducing device for reproducing an analog electrical signal from the recorded data according to the set rhythm speed and type to actuate the speaker.

### BACKGROUND OF THE INVENTION

1. Field of the Invention

The present invention relates to an electronic metronome capable of realizing an improved commercial value by using characteristics of analog sounds existing in nature and human society.

2. Description of the Prior Arts

There are known various types of tone generating apparatus. Examples of the apparatus are an alarm device disclosed in Japanese Patent Laid-open Publication No. 9-139761, a timer alarm device and an ear-mounting structure disclosed in Japanese Patent Laid-open Publication No. 9-105788, a timer device disclosed in Japanese Patent Laid-open Publication No.11-133166, a rhythm practicing device disclosed in Japanese Patent Laid-open Publication No. 2000-51422 and an ear-mounting device disclosed in Japanese Patent Application No. 2001-218980. Moreover, Japanese Patent Laid-open Publication No. 57-76475 discloses an example of electronic metronome outputting rhythm by means of English voice sounds such as “one”, “two”, “three”.

For example, the device disclosed in Japanese Patent Laid-open Publication No. 2000-51422 (Japanese Patent No. 3,295,051) has an electronic buzzer for reproducing rhythm signal sounds with a small volume in the vicinity of an ear hole of a user, a three-digit liquid crystal display device for displaying parameter of rhythm, switches for selecting parameters (type and speed) of rhythm by an operation of the user, an integrated circuit for displaying a selected parameter on the liquid crystal display device and generating an electrical signal of a rhythm corresponding to the selected parameter to actuate the electronic buzzer, a battery for supplying electric power to the integrated circuit, a casing structure for integrally housing these parts and an ear-mounting mechanism for positioning the electronic buzzer in the vicinity of the ear hole with the casing structure held on the ear by restricting a concha of the user. Here, the integrated circuit generates square-wave continuous voltage pulse to actuate the electronic buzzer.

Moreover, in the electronic metronome of Japanese Patent Laid-open Publication No. 57-76475, respective voice data of “one”, “two”, “three” are held in individual resistors and sequentially sent to a D/A converter in response to trigger signals synchronized with the rhythm.

When the electronic buzzer is actuated by the continuous voltage pulse with simple square wave, monotonous analog sound including noise is generated. Since this monotonous analog sound is mixed into ambient noise if volume is small, the user is liable to miss it. On the contrary, if the volume is large, the user feels unpleasant, and the sound is offensive to the user's ear because noise increases. A comfortable volume changes according to users' ages, individual differences and use environment. Therefore, if devices of which volume has been fixed and uniformly set are marketed, the degree of satisfaction of omitted users becomes low. However, if volume regulation is enabled and is left to the users, operation of the device attached to ear is complicated, cost increase is caused and degree of satisfaction of all users is lowered.

On the other hand, in case where respective sound data such as “one”, “two”, “three” are held in individual resistors and sequentially sent to the D/A converter in response to trigger signals synchronized with rhythm, a complicated dedicated circuit must be designed by combining numerous circuit elements including a resistor having vast numbers of bits, and hence problems such as increase in size and weight of a circuit and raise in manufacturing cost of the circuit exist in terms of marketability and practicability.

### SUMMARY OF THE INVENTION

It is an object of the present invention to provide an electronic metronome capable of preventing a user missing generated sounds even with a small volume by adding information other than physical amplitude and frequency into an output sound and increasing a range of a comfortable volume of sounds generated in the vicinity of an ear of the user and also to provide such a device at a low cost by reducing the number of assembly parts.

To accomplish the above objects, the present invention provides an electronic metronome comprising a sound outputting device for reproducing a signal sound, a switch device for selecting a parameter of a rhythm by an operation of a user, a display device for displaying a selected parameter, an electronic circuit for generating an electrical signal of a rhythm corresponding to the selected parameter to actuate the sound outputting device, a casing structure for integrally housing the sound outputting device, the switch device, the display device and the electronic circuit, and an ear-mounting mechanism for positioning the sound outputting device in the vicinity of an ear of the user with the casing structure held on the ear by restricting a concha of the user, wherein the electronic circuit has a memory for holding a recorded data and a reproducing device for reproducing an analog electrical signal of rhythm tone output from the recorded data according to the selected parameter.

In the electronic metronome of the present invention, the user selects and sets a parameter of rhythm by operating the switch device while seeing the display device. The memory stores sounds existing in nature and human society such as people's voices, handclaps, sounds of rhythm musical instruments, cries of animals, humming sounds of insects, thunder sound, brake sounds of an automobile, siren of a patrol car, as digital data in advance. The reproducing device reads out these digital data from the memory and repeatedly reproduces an analog electrical signal under a condition corresponding to a parameter. The sound outputting device reproduces “an analog sound of which kind and generation source can be intuitively understood by a user” from the analog electrical signal.

According to another aspect of the present invention, an electronic metronome comprises a sound outputting device for reproducing a signal sound, a switch device for selecting a parameter of a rhythm by an operation of a user, a display device for displaying a selected parameter, an electronic circuit for generating an electrical signal of a rhythm tone arrangement corresponding to the selected parameter to actuate the sound outputting device, a battery for supplying electric power to the electronic circuit, and a casing structure for integrally housing the sound outputting device, the switch device, the display device, the electronic circuit and the battery, wherein the electronic circuit includes a memory for holding a plurality of kinds of recorded data in which an analog sound is digitized for each rhythm tone constituting the rhythm, an arithmetic unit for generating a digital signal of a rhythm tone arrangement from the plurality of kinds of recorded data according to the selected parameter and an analog conversion circuit for generating an analog electrical signal of a rhythm output from the digital signal of a rhythm tone arrangement.

In this electronic metronome, there are used a plurality of kinds of recorded data in which the analog sound is digitalized for each rhythm sound constituting a rhythm pattern of 1 cycle. The arithmetic circuit arranges the plurality of kinds of recorded data on a time axis in the order and arrangement corresponding to a parameter set by the user, generates and inputs sound data of rhythm pattern of 1 cycle to the analog conversion circuit repeatedly. The analog conversion circuit converts the sound data of rhythm pattern into an analog electrical signal and continues outputting rhythm output corresponding to a selected parameter to the sound outputting device. Thereby, the electronic metronome of the present invention can be used as an electronic metronome.

According to the present invention, since the memory holds recorded data of analog sounds and the reproducing device reproduces analog electrical signals from recorded data, rhythm tones having many kinds of speeds and types can be generated by means of recorded data with relatively small volume. Therefore, small-size, light-weight and low-cost ear-mounting rhythm device and electronic metronome which have a reduced number of parts can be realized.

Moreover, due to the use of recorded data, information other than physical amplitude and frequency can be included in an output sound of rhythm or alarm, and a sound suitable for a use can be selected and utilized from a wide variety of sounds existing in nature and human society. Therefore, a range of volume at which the user is able to listen comfortably is increased, many people can utilize the sound comfortably even at common volume, and output sounds of rhythm or alarm are hardly missed even at a small volume. Moreover, the user is able to select a comfortable tone and keep his concentration even during a prolonged use and be freed from a harsh noise generated when an electronic buzzer is actuated with square waves. Further, a fanciful rhythm including language information such as “one”, “two”, “three” and the like can be easily utilized.

The above and further objects and features of the invention will be more fully apparent from the following description when the same is considered with reference to the accompanying drawings.

### BRIEF DESCRIPTION OF THE DRAWINGS

FIG. 1 is a vertical cross-sectional view of a first embodiment of the present invention.

FIG. 2 is a horizontal cross-sectional view of the first embodiment of the present invention.

FIG. 3 is a circuit diagram of the first embodiment.

FIG. 4 is an explanatory view showing displays in a mode for setting a rhythm speed.

FIG. 5 is an explanatory view showing displays in a mode for setting a type of rhythm.

FIG. 6 is an explanatory view of an output sound of the first embodiment.

FIG. 7 is an explanatory view showing displays in a mode for setting a type of signal sound.

FIG. 8 is an explanatory view of the type of signal sound.

FIG. 9 is an explanatory view showing an operation of a second embodiment of the present invention.

FIG. 10 is an explanatory view of a third embodiment of the present invention.

FIG. 11 is a circuit diagram of the third embodiment.

### DETAILED DESCRIPTION OF THE PREFERRED EMBODIMENTS

There will be described a first embodiment, in which the present invention is applied to an ear-mounting rhythm device.

The ear-mounting rhythm device of the first embodiment has been developed on the basis of an rhythm practicing device (electronic metronome) disclosed in Japanese Patent Laid-open Publication No. 2000-51422 and generates sound signals of rhythm tone in the vicinity of an ear hole of a user in the state of being mounted on the ear.

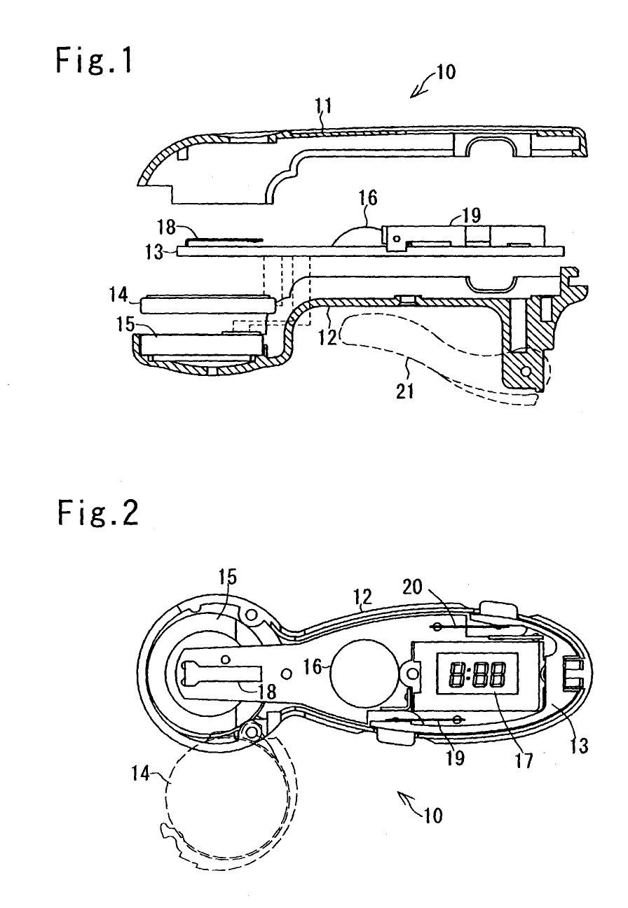

As shown in FIG. 1 and FIG. 2, an ear-mounting rhythm device 10 is assembled by sandwiching a printed circuit board 13, a button battery 14 and a speaker 15 between an upper casing 11 and a lower casing 12. On the printed circuit board 13, there are mounted an electrode for extracting an electric power from the button battery 14, a wiring for supplying an analog sound signal to the speaker 15, respective contacts of three push-type switches 18, 19, 20, an integrated circuit 16, a liquid crystal display 17 and other not-shown electronic parts. A clip 21 is rotatably fitted to an end of the lower casing 12. The button battery 14 is housed in an battery case fitted to the lower casing 12 and can be detached and exchanged by rotating the battery case to the outside of the lower casing 12, as indicated by broken lines in FIG. 2. The upper casing 11 and the lower casing 12 constitutes a casing structure.

The ear-mounting rhythm device 10 is designed in such a manner that a portion of the lower casing 12 housing the speaker 15 is placed in a recess around the ear hole and firmly held and also the speaker 15 acting as a sound outputting device is positioned in the vicinity of the ear hole, with the lower casing 12 and the clip 21 sandwiching a concha of the user so that the lower casing 12 is located on the ear.

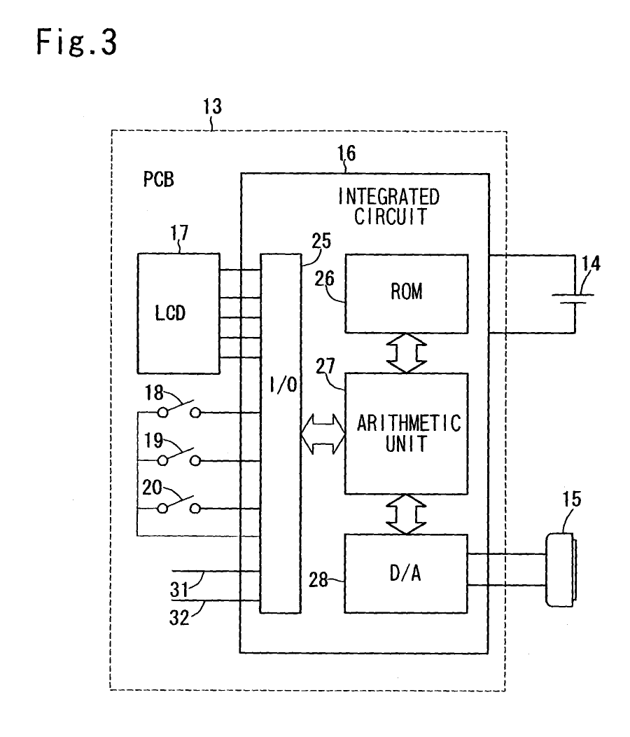

As shown in FIG. 3, the integrated circuit 16 fixed on the printed circuit board 13 is a sound processor in which an I/O circuit 25, a memory device 26, an arithmetic unit 27 including a RAM therein and a D/A converter 28 are arranged on a 1 chip. Such a sound processor is available on the market so as to be used for a sound reading-out electronic calculator, a recordable alarm clock, a sounding illustrated book, a talking doll, and the like.

The I/O circuit 25 latches and enters inputs of the switches 18, 19, 20 to the arithmetic unit 27, also latches an output signal of the arithmetic unit 27 and displays a numeral value of three digits on the liquid crystal display 17.

The memory device 26 holds a program or data used by the arithmetic unit 27 in a non-volatile state. Although data of the memory device 26 is controlled with a terminal 31 and can be rewritten with a serial data entered from a terminal 32, only sound data stored first are repeatedly used in the first embodiment and rewriting of existing sound data or addition of new sound data is not performed.

The D/A converter 28 converts a digital signal generated by the arithmetic unit 27 into an analog voltage signal to actuate the speaker 15. The arithmetic unit 27 and the D/A converter 28 constitute a reproducing device. The battery 14 supplies electric power to the integrated circuit 16.

The switch 18 enters a command to start/stop generation of rhythm alternately in response to a short depressing operation. If the switch 18 is kept depressed for one second or more, however, the system including the integrated circuit 16 is switched to a mode for changing a parameter of a rhythm. The switches 19, 20 disposed on separate sides across the liquid crystal display 17 are depressed with reference to the liquid crystal display 17 and successively changes alternatives of the parameter by the number of depression to set a parameter of rhythm.

If the switch 18 is kept depressed for one second or more, a mode for setting a rhythm speed is first established. Then, a numerical value representing the number of pulses per minute displayed in the liquid crystal display 17 starts to blink. In this state, each time the switch 19 is depressed, the numerical value is reduced, and each time the switch 20 is depressed, the numerical value is increased.

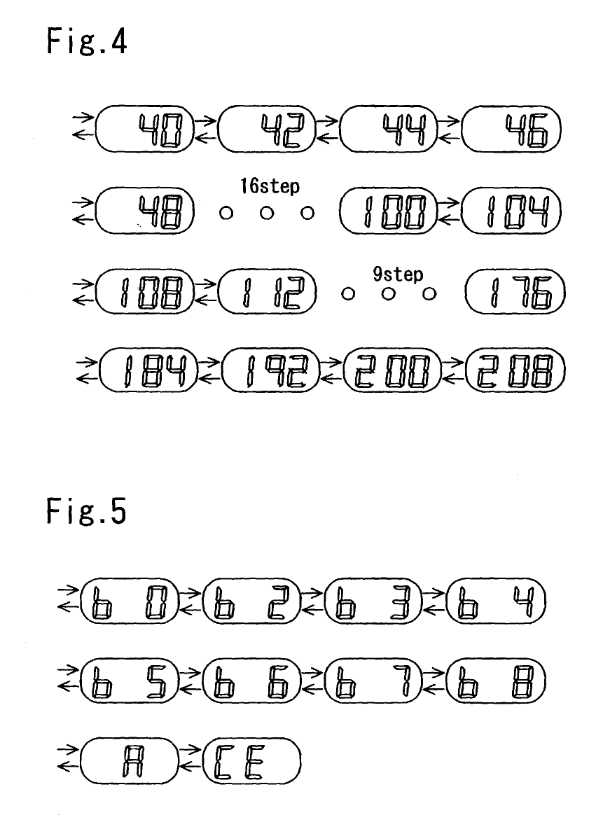

As shown in FIG. 4, rhythm speed can be selected at 39 levels in the range of 40 to 208 beats per minute. When the switch 18 is depressed or operations of the switches 19, 20 are stopped for two seconds, the number of pulses per minute of a numerical value displayed in the liquid crystal display 17 is confirmed as rhythm speed, and then rhythm tone of the rhythm speed starts being generated in response to a short depressing operation of the switch 18.

If the switch 18 is kept depressed for one minute or more in the rhythm speed change mode (the state where display shown in FIG. 4 blinks), a mode for changing a type of rhythm is established. By depressing the switches 19, 20 while a symbol of type of rhythm displayed in the liquid crystal display 17 blinks, the type of rhythm can be selected.

As shown in FIG. 5, one rhythm tone can be selected from eight types of rhythms and two types of tuning reference tones. When the switch 18 is depressed or the operations of the switches 19, 20 are stopped for two seconds, the selection of a type of rhythm (or a tuning reference tone) corresponding to a symbol displayed in the liquid crystal display 17 at that time is confirmed, and then a rhythm tone (or a tuning reference tone) of the type of rhythm starts being generated in response to the short operation of the switch 18.

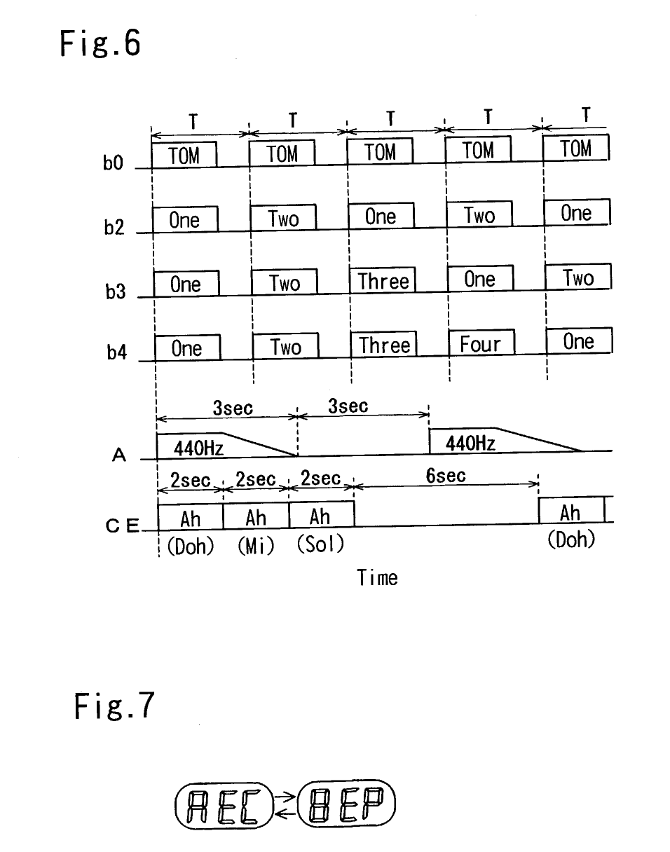

As shown in FIG. 6, the reference symbol b0 designates a rhythm tone such as tom-tom having no difference between strong beat and weak beat. And a recorded data of this rhythm tone is obtained by sampling a demonstration sound of a Chinese block and compressing and reducing an amount of data (recorded in a WAV format and held in an AD-PCM format in the integrated circuit 16). Various compression formats can be used for data compression. The reference symbols b2-b4 designates English rhythm tones having difference between strong beat and weak beat. And a recorded data of this rhythm tone is obtained by sampling demonstrated sounds of a rhythmic declamation by an American musician and compressing and reducing an amount of data. Rhythm interval T is obtained by calculation of (60 sec/displayed value of set rhythm speed (beats)).

The reference symbol A designates a mode of a tuning reference tone used for tuning a musical instrument, and a recorded data of this case is obtained by sampling tone of a tuning fork of 440 Hz and compressing and reducing an amount of data. A sine wave sound fading out in three seconds is repeatedly reproduced at intervals of three seconds.

The reference symbol CE designates a mode of a tuning reference tone used for tuning of a chorus sound. A recorded data of this case is obtained by sampling vocalization of a female singer and compressing and reducing an amount of data, and voice of the female singer singing a scale (doh, mi, sol) is repeatedly reproduced at intervals of 6 seconds.

If the switch 18 is kept depressed for one second or more in the mode for changing the type of rhythm (the state where display shown in FIG. 5 blinks), a mode for changing a type of signal sound is established. By operating the switches 19, 20 while the display shown in FIG. 7 blinks, one of a recorded sound (REC) and a composite tone (BEP) can be selected. If the switch 18 is depressed or the operations of the switches 19, 20 are stopped for two seconds, the selection of a type of signal sound corresponding to a symbol displayed then in the liquid crystal display 17 is confirmed.

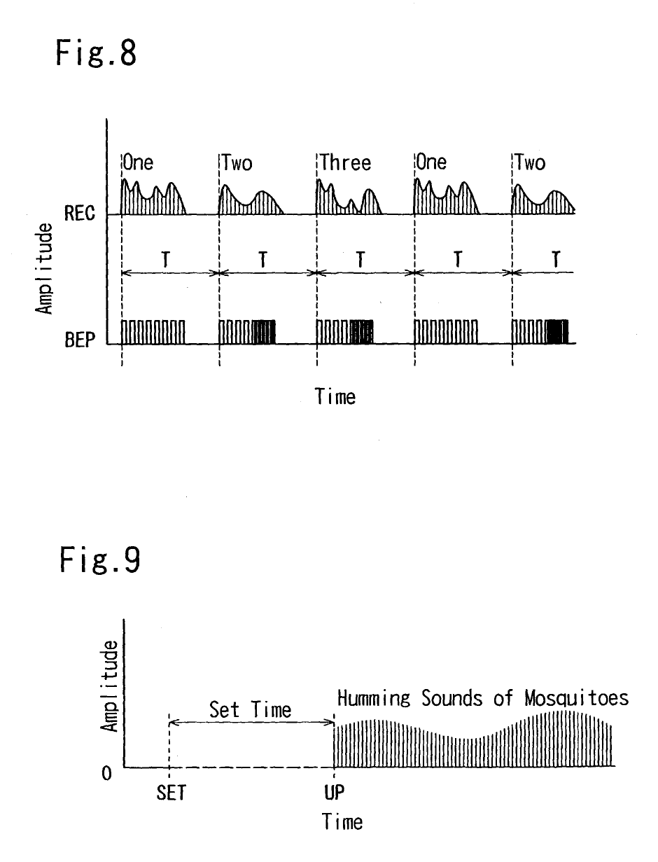

When the recorded sound (REC) is selected, as shown in FIG. 8 an analog electrical signal in which individual recorded data are arranged along a time axis is inputted to the speaker 15, as explained with reference to FIG. 6. On the other hand, when the composite tone (BEP) is selected, a square-wave intermittent continuous pulse generated independently of the recorded data by the arithmetic unit 27 is outputted. A continuous pulse of strong beat is long continued with a low frequency. As for a continuous pulse of weak beat, low frequency is allocated in the first half thereof, and a high frequency is allocated in the last half thereof. Thereby, modulation of strong beat and weak beat is given to rhythm tone to improve audibility.

In the ear-mounting rhythm device of the first embodiment constructed thus, the arithmetic unit 27 and the D/A converter 28 generate analog electrical signals of rhythm tone and tuning reference tone from recorded data of the memory device 26 according to a selected parameter, whereby highly impressive and prepossessing analog sounds existing in nature and human society can be used. Moreover, since familiar and highly prepossessing rhythm tones are adopted, the user does not fail to hear the rhythm tones even with a small volume compared to simple square-wave tones and can sustain his concentration power with little effort. Further, since highly prepossessing rhythm tones are adopted, all users, that is, young and old and also from hearing-impaired people to people with hyperacusis, can continue to hear these tones comfortably even with a fixed volume.

In the ear-mounting rhythm device, the memory device 26 holds the recorded data of the tuning reference tone, and when parameters of the modes A, CE are selected, an analog electrical signal with two types of tuning reference tones is reproduced from the recorded data. Therefore, the user can use the ear-mounting rhythm device for both tuning of musical instruments and tuning of chorus voices without carrying a conventional large metronome or tuning fork around.

Moreover, the memory device 26 holds recorded data of a plurality of kinds of short analog sounds, and the arithmetic unit 27 rearranges individual recorded data on time axis according to the selected parameter, whereby rhythm tones of many kinds of speeds and types and also tuning reference tones can be generated from recorded data of small capacity of twenty seconds or less in total. Therefore, it is possible to provide a small-sized and light-weight ear-mounting rhythm device which uses a low-cost integrated circuit and is reduced in the number of parts.

Moreover, the rhythm generating device is constituted by adopting the existing integrated circuit 16 in which the I/O circuit 25, the memory device 26, the arithmetic unit 27 and the D/A converter 28 are arranged on one chip and making changes to program, whereby the same size, weight and manufacturing cost as those of the conventional ear-mounting rhythm device generating beep tones can be achieved.

Further, since the memory device 26 stores recorded data in which English utterance of a native speaker is actually recorded, the ear-mounting rhythm device is used for music practices or sport practices and can output natural and comfortable rhythm tones.

Moreover, since the speaker is used as a sound outputting device, analog electrical signals can be precisely converted to sound waves, and compared to an electronic buzzer, favorable tones with little noise and wave distortion can be reproduced.

Further, a type of signal sound can be selected from the recorded sounds (REC) and the composite tones (BEP) by using the switches 18, 19 and 20, whereby the user can utilize the ear-mounting rhythm device even if he cannot understand English.

Moreover, since alternatives of the parameter are successively displayed in both directions of UP/DOWN by the switches 19, 20 disposed in the separate sides across the liquid crystal display 17, it is easy to turn back to a desired alternative in the case of having passed it. The user supports a portion of the casing structure of the ear hole side with one hand and can easily operate the switches 19, 20 with the thumb and forefinger of the other hand, and “UP” is arranged on the side of increasing a numerical value displayed on the liquid crystal display 17 and “DOWN” is arranged on the side of reducing the numerical value, whereby the user can know the result of operation by intuition and set the desired alternate quickly.

Although recorded data of the memory device 26 are obtained by sampling sounds or voices actually existing in the first embodiment, it is possible to generate recorded data in semblance of sounds existing in nature or human society by using technique of data composition. Moreover, recorded data may be obtained by sampling sounds of rhythm instruments, animals' cry, thunder sounds, brake sounds of automobiles, siren of patrol cars and the like in addition to human voices such as “un”, “deux”, “trois”.

In case where the whole device is reduced in size and weight, moreover, the casing structure becomes lighter and short of its rigidity, and reproduction volume of a low tone range becomes insufficient. For this reason, a control program may be changed so that a signal processing for lowering a level of a high tone range is performed with the arithmetic unit 27 when analog electrical signals are reproduced from recorded data. In case where the printed circuit board 13 and the battery case in the casing structure are supported in cantilever fashion, the arithmetic unit may be also controlled to perform a signal processing for intentionally reducing a frequency component corresponding to resonance frequency of cantilever members in order to restrict occurrence of noise or unnatural tones caused by resonance. Correction of a necessary sound spectrum may not be performed by the arithmetic unit 27, but recorded data requiring no correction may be stored in the memory device 26 by correcting sound spectrum of a sound source at the time of recording samples or by adding a necessary data correction at the stage of generating recorded data.

Although a mode setting of three stages is performed by the switch 18 also used as an ON/OFF switch in the first embodiment, a first stage is allocated to a rhythm speed, a second stage is allocated to a type of rhythm and a tuning reference tone, and a third stage is allocated to a type of signal sound, a mode setting of two stage may be established by performing a selection of the type of signal sound at the second stage. In this case, alternatives of a number obtained by multiplying types of rhythm by types of signal sounds are prepared in the second stage, and one of four time of a recorded tone and four time of a composite tone is selected at the same setting stage.

Next, there will be described a second embodiment of the present invention.

FIG. 9 is an explanatory view of the device of the second embodiment. This device has been developed on the basis of the timer alarm device disclosed in Japanese Patent Laid-open Publication No. 9-105788 (Patent No. 3,160,756) and uses the same components, structure and integrated circuit as in the ear-mounting rhythm device of the first embodiment as shown in FIG. 1 to FIG. 3, and a count-down timer is realized by changing only a microcomputer control program of system.

In the second embodiment, a recorded data of humming sounds of mosquitoes and a processing program of the count-down timer are held in the memory device 29. Time till 8 hours and 59 minutes can be set by operating the switches 19, 20 while seeing the liquid crystal display 17. If the switch 18 is operated after a time is set, time-counting is started, and time displayed on the liquid crystal display 17 starts being counted down. If the time displayed on the liquid crystal display 17 reaches 0, the arithmetic unit 27 reads out the recorded data of humming sounds of the mosquitoes and generates a digital signal of an alarm tone, and the digital signal of the alarm tone is converted to an analog electrical signal by the D/A converter 28. Thus, the alarm tone of the mosquitoes' humming sounds is outputted from the speaker 15. Other constructions such as the casing structure and the like are identical to those of the first embodiment.

Since the second embodiment has the same hardware configurations as the first embodiment, a cost for die assembly and parts cost are reduced because these devices are related products, and a low-cost product can be provided. Moreover, since the alarm tone is composed of the mosquitoes' humming sounds having an unusually high stimulating feeling with respect to audibility of the human ear, an alarm can be certainly transmitted to the user even under severe noisy environment such as a manufacturing plant or an underpass of elevated railroad. Even in case where a usual tone does not arrest attention of the user who sleeps deeply or concentrates upon his work extremely, the alarm tone of this ear-mounting timer device can attract the user's attention immediately and inform him of time lapse certainly.

Although the second embodiment was explained as an independent device, it may be manufactured by mounting a timer with humming-sound alarm as an additional function in the rhythm device of the first embodiment. In this case, a timer function may be selected in the second stage of the mode setting by the switch 18, that is, as one of the types of rhythm shown in FIG. 5.

Moreover, one of the timer function and rhythm function may be selected and fixed in the manufacturing stage by attaching a changeover switch that cannot be operated from the outside (or a short-circuited jumper wiring) on the printed circuit board 13. Also in this case, since parts and manufacturing process are common to the rhythm device and the timer device, store compaction can be expected by cost reduction due to mass production and type change of stock devices.

Next, a third embodiment will be described.

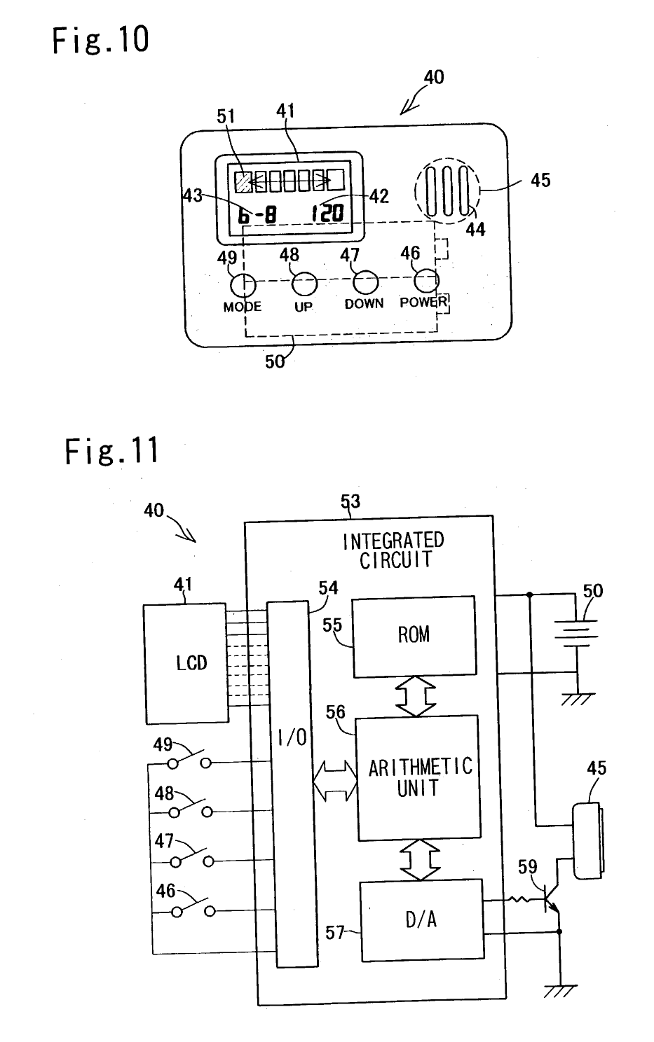

FIG. 10 is an outline view of the third embodiment, and FIG. 11 is a circuit diagram of the same. This electronic metronome 40 utilizes a general-purpose integrated circuit 53 prepared by molding the integrated circuit 16 of the first embodiment in a standard package, and a speaker 45 is indirectly actuated using a transistor 59 and reproduction volume is digitally adjustable at five levels in total.

As shown in FIG. 10, a liquid crystal display 41, a slit 44 and push-type switches 46, 47, 48, 49 are arranged on a top surface of the casing structure. The switch 46 enters a command to start/stop generation of rhythm alternately in response to a depressing operation. The switch 49 enters a command for a mode for setting parameter, and the switches 48, 47 enter commands for successive displays of alternatives of parameter in an UP direction and a DOWN direction respectively.

The speaker 45 is disposed behind the slit 44. In the casing structure, the liquid crystal display 41 is assembled on a not-shown printed circuit board, on which contacts of the respective switches 46, 47, 48, 49 are formed. Two batteries 50 are housed behind the printed circuit board. The liquid crystal display 41 displays a set type 43 of rhythm together with a set rhythm speed 42 and simultaneously displays a rhythm sign 51 of a pendulum swaying from side to side in synchronization with outputted rhythm.

As shown in FIG. 11, the integrated circuit 53 is a 1 chip microcomputer device wherein an I/O circuit 54, a memory device 55, an arithmetic unit 56 and a D/A converter 57 are formed on a common semiconductor substrate. The integrated circuit 53 is supplied with electric power from the batteries 50 and two kinds of high/low clock signals from two not-shown quartz oscillators. The integrated circuit 53 holds parameters set by operating the switches 47, 48, 49 and outputs analog electrical signals of rhythm corresponding to the selected parameters by using recorded data stored in the memory device 55 as in the first embodiment when the switch 46 is depressed. The analog electrical signals are amplified with the transistor 59 to actuate the speaker 45.

The memory device 55 has a capacity of 64 kB and stores a series of processing program of 20 kB and data of 60 kB. This data includes a table of time and a table of arrangement, respectively corresponding to parameters, and also various types of sound data. The sound data are obtained by compressing one byte sized source data recorded with a sampling frequency of 6.1 kHz and includes data of the same types and numbers as in the first embodiment as short recorded data of each rhythm tone constituting rhythm such as “one”, “two”, as shown in FIGS. 6 and 8. The arithmetic unit 56 refers to the tables of time and arrangement according to parameters of set speeds and types, reads out an available recorded data in an order corresponding to a type of rhythm and at time intervals corresponding to a rhythm speed, uncompresses its compressed state, generates a digital signal in which an one-byte data is serially outputted for each sampling interval and sends it to the D/A converter 57. The D/A converter 57 converts a digital signal of a rhythm tone arrangement generated by the arithmetic unit 56 to an analog electrical signal and controls base current of the transistor 59. The speaker 45 is actuated by an analog electrical signal that is extracted from the batteries 50 and controlled by the transistor 59 and outputs rhythm wherein reproduced sounds of recorded data are arranged.

If the switch 49 is depressed once in a stop state of rhythm output, the mode for setting a rhythm speed is established, and the rhythm speed 42 displayed in the liquid crystal display 41 blinks. As in the first embodiment, the alternatives of the parameter are successively displayed in the UP/DOWN directions by the switches 48, 47, and a desired one of the alternatives shown in FIG. 4 can be selected. Moreover, if the switch 49 is depressed once in the state where the rhythm speed 42 blinks, the mode for setting a type of rhythm is established, and the type 43 of rhythm displayed in the liquid crystal display 41 blinks. Also, as in the first embodiment, the alternatives of the parameter are successively displayed in the UP/DOWN directions by the switches 48, 47, and a desired one of the alternatives shown in FIGS. 5 and 6 can be selected.

On the other hand, the switches 47, 48 serve to enter a command to control volume during output of rhythm, and the user can select one of volumes of total five levels comprising a standard volume and two upper and lower levels. If the switch 47 is depressed once in an output state of the standard volume, a volume of rhythm output is reduced by one level, and if the switch 47 is depressed twice, the volume is reduced by two levels. If the switch 48 is depressed once, the volume is increased by one level, and if the switch 48 is depressed twice, the volume is increased by two levels. Even when the switch 46 is depressed to stop the rhythm output, the volume set thus is held and is reflected also at the time of starting a next rhythm output. This volume control is programmed using a command function built into the integrated circuit 53.

According to the electronic metronome of the third embodiment, the set rhythm speed 42 and type 43 of rhythm are always displayed in the liquid crystal display 41, whereby an error in setting of a parameter at the time of start of rhythm can be prevented and the content of setting can be accurately recognized even during output of rhythm. The liquid crystal display 41 displays the rhythm sign 51 of the pendulum swaying in synchronization with a rhythm tone to be generated, and hence rhythm tone being generated can be confirmed also with the user's eyes. Moreover, since volume of rhythm output can be controlled by operating the switches 47, 48, it is possible to set the most appropriate volume according to various kinds of circumstances or the user's hearing. Since the volume control is performed using command functions installed in the integrated circuit 53, the volume control can be realized by combination of the integrated circuit 53 with a slow processing speed and a small sized program, whereby it is possible to save power consumption and prolong life of the battery 50, as compared to the case where a variable resistor is connected in series with the speaker 45 to thermally convert surplus power.

The integrated circuit 53 is housed in a standard package from which dozens of solder terminals are led out. Therefore, the ear-mounting rhythm device as described in the first embodiment can be realized by bonding and molding only chips of the integrated circuit 53 directly to the printed circuit board 13. On the other hand, it is also possible to realize the electronic metronome of the third embodiment by using the integrated circuit 16 of the first embodiment.

What is claimed is:

1. An electronic metronome, comprising:
a sound outputting device for reproducing a signal sound;
a switch device for selecting a parameter of a rhythm by an operation of a user;
a display device for displaying a selected parameter;
an electronic circuit for generating an electrical signal of a rhythm corresponding to the selected parameter to actuate the sound outputting device;
a casing structure for integrally housing the sound outputting device, the switch device, the display device and the electronic circuit, and
an ear-mounting mechanism for positioning the sound outputting device in the vicinity of an ear hole of the user with the casing structure held on the ear by restricting a concha of the user,
wherein the electronic circuit has a memory for holding a recorded data and a reproducing device for reproducing an analog electrical signal of rhythm tone output from the recorded data according to the selected parameter.

2. An electronic metronome according to claim 1, wherein
the memory and the reproducing device are arranged on a one-chip microcomputer device, and the electronic circuit is programmed to be capable of changing a speed and a type of a rhythm tone.

3. An electronic metronome, comprising:
a sound outputting device for reproducing a signal sound;
a switch device for selecting a parameter of a rhythm by an operation of a user,
a display device for displaying a selected parameter;
an electronic circuit for generating an electrical signal of a rhythm corresponding to the selected parameter to actuate the sound outputting device;
a casing structure for integrally housing the sound outputting device, the switch device, the display device and the electronic circuit, and
an ear-mounting mechanism for positioning the sound outputting device in the vicinity of an ear hole of the user with the casing structure held on the ear by restricting a concha of the user,
wherein the electronic circuit has a memory for holding a recorded data of a rhythm tone in advance and a reproducing device for reading out the recorded data of the memory according to the selected parameter and reproducing an analog electrical signal of the rhythm tone repeatedly.

4. An electronic metronome according to claim 3, wherein
parameters of the rhythm are a type of rhythm and a rhythm speed, the memory stores recorded data of a plurality of types of rhythm tones, and the reproducing device arranges the recorded data of the plurality of types of rhythm tones in an order of types of rhythm and at time intervals corresponding to a rhythm speed, which types and speed are selected by the switch device, and reproduces an analog electrical signal of rhythm output.

5. An electronic metronome according to claim 3 or 4, wherein
the memory stores a recorded data of a tuning reference tone in advance, and the reproducing device reads out the recorded data of a tuning reference tone when a tuning reference tone is selected as a parameter and reproduces an analog electrical signal of the tuning reference tone repeatedly.

6. An electronic metronome according to claim 3 or 4, wherein
the switch device has a pair of push-type switches which are disposed on separated sides of the casing structure across the display device and assigned to directions of an UP and a DOWN, and the parameter is displayed in the display device successively in both directions of UP/DOWN according to operations of the pair of push-type switches.

7. An electronic metronome according claim 3 or 4, wherein
the recorded data are data digitally recorded by sampling actual play-sounds and then compressed in a predetermined format.

8. An electronic metronome, comprising:
a sound outputting device for reproducing a signal sound;
a switch device for selecting a parameter of a rhythm by an operation of a user;
a display device for displaying a selected parameter;
an electronic circuit for generating an electrical signal of a rhythm tone arrangement corresponding to the selected parameter to actuate the sound outputting device;
a battery for supplying electric power to the electronic circuit, and
a casing structure for integrally housing the sound outputting device, the switch device, the display device, the electronic circuit and the battery,
wherein the electronic circuit includes a memory for holding a plurality of kinds of recorded data in which an analog sound is digitized for each rhythm tone constituting the rhythm, an arithmetic unit for generating a digital signal of a rhythm tone arrangement from the plurality of kinds of recorded data according to the selected parameter and an analog conversion circuit for generating an analog electrical signal of a rhythm output from the digital signal of a rhythm tone arrangement.

9. An electronic metronome, comprising:
a sound outputting device for reproducing a signal sound;
a switch device for selecting a type of rhythm and a rhythm speed by an operation of a user;
a display device for displaying the selected type of rhythm and the selected rhythm speed;
an electronic circuit for generating an electrical signal of a rhythm tone arrangement corresponding to the selected type of rhythm and the selected rhythm speed to actuate the sound outputting device;
a battery for supplying electric power to the electronic circuit, and
a casing structure for integrally housing the sound outputting device, the switch device, the display device, the electronic circuit and the battery,
wherein the electronic circuit includes a memory for storing a recorded data of a plurality of types of rhythm tones in advance and a reproducing device for arranging the recorded data of the plurality of types of rhythm tones in an order corresponding to the selected type of rhythm and at time intervals corresponding to the selected rhythm speed and generating an analog electrical signal of a rhythm tone arrangement.

10. An electronic metronome according to claim 9, further comprising
a volume setting device for setting a volume level of a rhythm by an operation of the user,
wherein the reproducing device changes an amplitude of the analog electrical signal according to the volume level set by the volume setting device.

11. An electronic metronome according to claim 10, wherein
the volume setting device includes a push-type switch functioning also as the switch device.

12. An electronic metronome, comprising:
a sound outputting device for reproducing a signal sound;
an electronic circuit for generating an electrical signal of a rhythm tone arrangement to actuate the sound outputting device;
a switch device for entering a command including a selection signal for selecting a parameter of a rhythm to the electronic circuit by an operation of a user;
a battery for supplying electric power to the electronic circuit, and
a casing structure for integrally housing the sound outputting device, the electronic circuit, the switch device and the battery,
wherein the electronic circuit is a microcomputer circuit, in which a memory for holding a recorded data for each rhythm tone constituting a rhythm and a reproducing device for arranging a plurality of kinds of recorded data according to the selected parameter to generate an analog electrical signal of rhythm output and at the same time changing an amplitude of the analog electrical signal in a plurality of levels in response to a predetermined command input are mounted together on a single chip, and capable of changing a volume of a rhythm tone outputted from the sound outputting device by an operation of the switch device.

13. An electronic metronome, comprising:
a sound outputting device for reproducing a signal sound;
a switch device for setting a reproduction timing of a signal sound by an operation of a user;
an electronic circuit for generating an electrical signal of an alarm when a set reproduction timing is attained and actuating the sound outputting device;
a casing structure for integrally housing the sound outputting device, the switch device and the electronic circuit, and
an ear-mounting mechanism for positioning the sound outputting device in the vicinity of an ear hole of the user with the casing structure held on the ear by restricting a concha of the user,
wherein the electronic circuit has a memory for holding a recorded data of an alarm sound and a reproducing device for reading out the recorded data of an alarm sound from the memory at the set reproduction timing and reproducing an analog electrical signal.

14. An electronic metronome according to claim 13, wherein
the reproducing device reproduces the recorded data of an alarm sound repeatedly to generate the analog electrical signal.

15. An electronic metronome according to claim 14, wherein
the recorded data of an alarm sound is a sound data digitally recorded by sampling humming sounds of a mosquito and then compressed in a predetermined format

16. An electronic metronome according to claim 3 or 13, wherein
the memory of the electronic circuit holds a composite tone data in addition to the recorded data and has a selecting device for selecting one of the recorded data and the composite tone data by an operation of the user, and the electronic circuit outputs an analog electrical signal to the sound outputting device by repeatedly utilizing the recorded data when the recorded data is selected and outputs an intermittent continuous pulse signal generated independently of the recorded data to the sound outputting device when the composite tone data is selected.

17. An electronic metronome according to claim 3 or 13, wherein
the sound outputting device is a speaker.

18. An electronic metronome according to claim 3 or 13, wherein
the recorded data held by the memory is generated by sampling and recording corrected sounds of actual sounds or by digitally correcting and processing a recorded data obtained from the actual sounds, so that reproduction sounds outputted in the vicinity of the ear hole through the sound outputting device housed in the casing structure become similar to audible sounds of the case where the actual sounds are heard.

19. An electronic metronome, comprising:
a sound outputting device for reproducing a signal sound;
a setting device for setting a parameter of a sound output by an operation of a user;
a display device for displaying a set parameter;
an electronic circuit for generating an electrical signal corresponding to the set parameter to actuate the sound outputting device;
a casing structure for integrally housing the sound outputting device, the setting device, the display device and the electronic circuit;
a selecting device for selecting one of a timer function and an electronic metronome function, and
an ear-mounting mechanism for positioning the sound outputting device in the vicinity of an ear hole of the user with the casing structure held on the ear by restricting a concha of the user,
wherein the electronic circuit has a memory for storing a recorded data of a rhythm tone and a recorded data of an alarm sound and a reproducing device for reproducing an analog electrical signal by reading out one of the recorded data of a rhythm tone and the recorded data of an alarm sound, and the reproducing device reads out the recorded data of a rhythm tone from the memory according to a parameter of a rhythm set by the setting device when the electronic metronome function is selected by the selecting device and on the other hand reads out the recorded data of an alarm sound from the memory according to a parameter of an alarm timing set by the setting device when the timer function is selected by the selecting device.
